(19) United States
(12) Patent Application Publication
(10) Pub. No.: US 2014/0350867 A1
(43) Pub. Date: Nov. 27, 2014

(54) SYSTEM FOR PRODUCING LIQUID COMPOSITION

(71) Applicant: AXALTA COATING SYSTEMS IP CO., LLC, Wilmington, DE (US)

(72) Inventors: Jeff B. Alspach, Lake Orion, MI (US); Gary T. Weaks, Troy, MI (US); Robert K. Vandette, Rochester, MI (US); Brian James Ladd, Ortonvile, MI (US); Allan Blase Joseph Rodrigues, Bloomfield Hills, MI (US)

(21) Appl. No.: 14/361,333

(22) PCT Filed: Nov. 20, 2012
(86) PCT No.: PCT/US2012/066001

§ 371 Date: May 29, 2014

Related U.S. Application Data
(60) Provisional application No. 61/564,324, filed on Nov. 29, 2011.
(60) Provisional application No. 61/564,322, filed on Nov. 29, 2011.
(60) Provisional application No. 61/564,326, filed on Nov. 29, 2011.

(51) Int. Cl. G06F 19/00

(52) U.S. Cl. CPC G06F 19/708; G06F 19/707
USPC 702/28

(57) ABSTRACT

The present invention is directed to a system for producing a target composition having one or more target property values. The system provides real time measurements of property values of the target composition being produced. The system can further provide real time image of the target composition for quality control and adjustment on one or more property values, such as color property values. The system can be used for producing the target composition, such as coating compositions, with improved quality control and increased productivity. The system can be used for OEM or refinish coating manufacturing or small volume paint mixing or adjustment operations.

### FIELD OF DISCLOSURE

The present disclosure is directed to a process for producing a target composition having one or more target property values. The disclosure is also directed to a system for producing a target composition having one or more target property values using the process disclosed herein.

### BACKGROUND OF DISCLOSURE

Compositions such as inks and coating compositions can be typically produced in liquid forms and can be produce into dry forms for industrial or consumer applications, such as printed materials or coatings on vehicles, appliances, or buildings. Production of such compositions can involve complex processes. The composition can have a plurality of properties including wet properties such as pH, viscosity, or wet color; and dry properties such as hardness or dry color. Typically, some of the wet properties can be different from the dry properties for the same composition. For example, wet color of a coating composition can be different from dry color of the same coating composition after cured or otherwise dried.

Currently, in order to produce a composition having desired dry properties, repeated tries and adjustments can be involved and can include the steps of producing an intermediate of the composition, drying it to form a dried composition, measuring dry properties of the dried composition, adjusting the composition, and repeat again until the desired properties are achieved. Such process is time and effort consuming and leads to time delays in production. For example, a coating composition batch can stay in a mixing tank for an extended time period while tests are run in control labs for producing dry samples to test coating properties.

Thus, needs exist for improved process to produce liquid composition having desired properties.

### STATEMENT OF DISCLOSURE

This disclosure is directed to process for producing a target composition having one or more target property values, the process comprising the steps of:
A1) obtaining specimen property values of a first specimen of a first intermediate mixture of the target composition, wherein the specimen property values comprise wet color data of the first specimen;
A2) comparing the specimen property values with the one or more target property values; and
A3) outputting the target composition if each of the specimen property values is within a predetermined individual tolerance range, or producing one or more subsequent intermediate mixtures of the target composition if one or more of the specimen property values are not within the predetermined individual tolerance range, each of the one or more subsequent intermediate mixtures is produced by adjusting, sequentially or simultaneously, one or more individual components of the target composition, one or more adjustment components of the target composition, or a combination thereof;

wherein the target property values comprise target color characteristics selected from wet target color characteristics, dry target color characteristics, or a combination thereof.

This disclosure is also directed to a system for producing a target composition having one or more target property values, the system comprising:
(A) one or more liquid measuring devices (1) for measuring specimen property values of a specimen of the target composition, the one or more liquid measuring devices comprise a wet color measuring device for obtaining wet color data of the specimen;
(B) a first computing device (2);
(C) one or more display devices (3), wherein the first computing device is functionally coupled to the one or more liquid measuring devices, the one or more display devices, or a combination thereof; and
(D) one or more digital data storage devices containing a computing program product functionally coupled to the first computing device, the computing program product comprises computing program codes for:
   D1) receiving the specimen property values from the one or more liquid measuring devices;
   D2) generating at least one specimen image comprising specimen color display values based on the wet color data; and
   D3) displaying the at least one specimen image having the specimen color display values on the one or more display devices.

This disclosure is further directed to a kit for use in a system for producing a target composition having one or more target property values, the kit comprising:
K1) a wet color measuring device for measuring wet color data of a specimen of the target composition;
K2) one or more digital storage devices containing a computing program product comprising computing program codes for:
   F1) receiving the wet color data from the wet color measuring device;
   F2) generating at least one specimen image comprising specimen color display values based on the wet color data; and
   F3) displaying the at least one specimen image having the specimen color display values on one or more display devices when present.

### BRIEF DESCRIPTION OF DRAWING

FIG. 1 shows examples of schematic representations of the system, wherein one or more liquid measuring devices can be connected to the mixing device via one or more control valves, input and output lines (A and B) or separated from the mixing device (C and D). A specimen of the target composition can be introduced into one or more liquid measuring device simultaneously (A and C) or sequentially (B and D).

FIG. 2 shows examples of schematic representations of viewing angles and illumination angles under transmittance (A) or reflectance (B) configurations.

FIG. 3 shows examples of schematic representations of thin film devices with a vertical configuration (A), a tilted configuration (B), a horizontal configuration (C), a spinning configuration (D), a vertical reflectance configuration (E), a vertical transmittance configuration (F), a horizontal reflectance configuration (G) and a horizontal transmittance configuration (H).

FIG. 4 shows examples of flow charts of the process: (A) sequential measurements of specimen properties with individual adjustment for each of the specimen properties; (B) simultaneous measurements of specimen properties with individual adjustment for each of the specimen properties; and (C) simultaneous measurements of specimen properties with composite adjustment for the specimen properties.

FIG. 5 shows an example of a flow chart for comparing color data.

FIG. 6 shows examples of schematic representations of displays: (A) a specimen image displayed interlaced with a target image and images representing a color tolerance range, and (B) a specimen image and a target image displayed simultaneously over a hiding mark.

FIG. 7 shows schematic representations of examples for measuring hiding data: (A) a circular disk having high contrast areas; (B) and (C) flow cells having high contrast areas; and (D) a static film over a hiding marker.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “dye” means a colorant or colorants that produce color or colors and is usually soluble in a coating composition.

The term “pigment” or “pigments” used herein refers to a colorant or colorants that produce color or colors and is usually not soluble in a coating composition. A pigment can be from natural and synthetic sources and made of organic or inorganic constituents. A pigment can also include metallic particles or flakes with specific or mixed shapes and dimensions. The term “effect pigment” or “effect pigments” refers to pigments that produce special effects in a coating. Examples of effect pigments can include, but not limited to, light absorbing pigment, light scattering pigments, light interference pigments, and light reflecting pigments. Metallic flakes, for example aluminum flakes, can be examples of such effect pigments. The term “gonioapparent flakes”, “gonioapparent pigment” or “gonioapparent pigments” refers to pigment or pigments pertaining to change in color, appearance, or a combination thereof with change in illumination angle or viewing angle. Metallic flakes, such as aluminum flakes are examples of gonioapparent pigments. Interference pigments or pearlescent pigments can be further examples of gonioapparent pigments.

“Appearance” used herein refers to (1) the aspect of visual experience by which a coating or an object is viewed or recognized; and (2) perception in which the spectral and geometric aspects of a coating or an object is integrated with its illuminating and viewing environment. In general, appearance can include shape, texture, sparkle, glitter, gloss, transparency, color, opacity, other visual effects of a coating or an object, or a combination thereof. Appearance can vary with varying viewing angles or varying illumination angles.

The term “texture”, “textures”, or “texture of coating” refers to coating appearances that are resulted from the presence of flakes or other effect pigment or pigments in the coating composition. The flakes can include, such as, metallic flakes like aluminum flakes, coated aluminum flakes, interference pigments, like mica flakes coated with metal oxide pigments, such as, titanium dioxide coated mica flake or iron oxide coated mica flake, diffractive flakes, such as, vapor deposited coating of a dielectric over finely grooved aluminum flakes. The term can also include the visual texture, such as coarseness, and the smoothness of the film, such as roughness of the surface of the film.

The term “sparkle”, “sparkles”, “sparkling” or “sparkle effect” refers to the visual contrast between the appearance of highlights on particles of gonioapparent pigments and their immediate surroundings. Sparkle can be defined by, for example, ASTM E284 and other standards or methods.

The term “flop” refers to a difference in appearance of a material viewed over two widely different aspecular angles. As used herein, the term “flop value”, “flop values” or “flop index” refers to a numerical scale of flop obtained by instrumental or visual experiments, or derived from calculations based on color data. In one example, flop index can be defined by ASTM E284 or other standards or methods.

The term “database” refers to a collection of related information that can be searched and retrieved. The database can be a searchable electronic numerical or textual document, a searchable PDF document, a Microsoft Excel® spreadsheet, an Microsoft Access® database (both supplied by Microsoft Corporation of Redmond, Wash.), an Oracle® database (supplied by Oracle Corporation of Redwood Shores, Calif.), or a Lynux database, each registered under their respective trademarks. The database can be a set of electronic documents, photographs, images, diagrams, or drawings, residing in one or more computer readable storage media that can be searched and retrieved. A database can be a single database or a set of related databases or a group of unrelated databases. “Related database” means that there is at least one common information element in the related databases that can be used to relate such databases. One example of the related databases can be Oracle® relational databases. In one example, color characteristics comprising color data values such as L,a,b color values, L*,a*,b* color values, XYZ color values, L,C,h color values, spectral reflectance values, light absorption (K) and scattering (S) values (also known as “K,S values”), or a combination thereof, can be stored in and retrieved from one or more databases. Other color values such as Hunter Lab color values, ANLAB color values, CIE LAB color values, CIE LUV color values, L*,C*,H* color values, any other color values known to or developed by those skilled in the art, or a combination thereof, can also be used. In another example, appearance characteristics, sparkle values and related measurements, coating formulations, vehicle data, or a combination thereof, can be stored and retrieved from one or more databases.

The term “vehicle”, “automotive”, “automobile”, “automotive vehicle”, or “automobile vehicle” refers to an automobile such as car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

A computing device used herein can refer to a data processing chip, a desktop computer, a laptop computer, a pocket PC, a personal digital assistant (PDA), a handheld electronic processing device, a smart phone that combines the functionality of a PDA and a mobile phone, or any other electronic devices that can process information automatically. A computing device can be built into other electronic devices, such as a built-in data processing chip integrated into an imaging device, color measuring device, or an appearance measuring device. A computing device can have one or more wired or wireless connections to a database, to another computing device, or a combination thereof. A computing device can be a client computer that communicates with a host computer in a multi-computer client-host system connected via a wired or wireless network including intranet and internet. A computing device can also be configured to be coupled with a data input or output device via wired or wireless connections. For example, a laptop computer can have data input devices such as key board, USB connections, or a touch screen and can be operatively configured to receive data and images through wired or wireless connections. A “portable computing device” can include a laptop computer, a pocket PC, a personal digital assistant (PDA), a handheld electronic processing device, a mobile phone, a smart phone, a tablet computer, or any other electronic devices that can process information and data and can be carried by a person.

Wired connections can include hardware couplings, splitters, adaptors, connectors, cables or wires. Wireless connections and devices can include, but not limited to, Wi-Fi device, Bluetooth device, wide area network (WAN) wireless device, local area network (LAN) device, infrared communication device, optical data transfer device, radio transmitter and optionally receiver, wireless phone, wireless phone adaptor card, or any other devices that can transmit signals in a wide range of radio frequency including visible or invisible optical wavelengths and electromagnetic wavelengths.

The term “wet” refers to a state of being liquid that is able to flow or adapt into a shape, such as the shape of a container or a substrate. Examples of wet compositions can include wet inks that have not dried or cured or wet coating compositions that have not dried or cured. A wet coating composition can be in a storage container or over a coated substrate and can adapt to the shape of the container or the shape of the substrate. A wet coating composition can comprise one or more liquid solvents, such as water, one or more organic solvents, one or more inorganic solvents, or a combination thereof. The “wet” property values refer to the property associated with a composition values when the composition is being wet. A wet coating composition refers to a film or surface of the coating composition that is wet and not dry to be touched as determined by ASTM D1640.

The term “dry” refers to a state of being solid. A dry composition can have a defined shape and can lack of liquid. Examples of dry compositions can include dried inks that have dried or cured or dry coating compositions that have dried or cured. A dry coating composition can be in a storage container or over a coated substrate. A dry coating composition can be formed by drying or evaporating liquid solvents, such as water, one or more organic solvents, one or more inorganic solvents, or a combination thereof, from a wet coating compositions. A dry coating composition can also be formed by drying off the liquid solvents or reacting some or all of the liquid solvents, such as reactive diluents, into solid. The “dry” property values refer to property values associated with a composition when the composition is being dry. A dry coating composition refers to a film or surface of the coating composition that is dry to be touched as determined by ASTM D1640. A dry coating can be dried due to full or partial curing reaction such as crosslinking or irradiation, solvent evaporation or removal, or a combination thereof.

This disclosure is directed to a process for producing a target composition having one or more target property values. The process can comprise the steps of:

A1) obtaining specimen property values of a first specimen of a first intermediate mixture of the target composition, wherein the specimen property values comprise wet color data of the first specimen;

A2) comparing the specimen property values with the one or more target property values; and

A3) outputting the target composition if each of the specimen property values is within a predetermined individual tolerance range, or producing one or more subsequent intermediate mixtures of the target composition if one or more of the specimen property values are not within the predetermined individual tolerance range, each of the one or more subsequent intermediate mixtures is produced by adjusting, sequentially or simultaneously, one or more individual components of the target composition, one or more adjustment components of the target composition, or a combination thereof;

wherein the target property values can comprise target color characteristics selected from wet target color characteristics, dry target color characteristics, or a combination thereof.

Depending on the nature, the target composition can be outputted into a variety of receiving devices. For example, when the target composition is an ink composition, the receiving device can comprise ink cartridges, packaging containers, storage containers, a subsequent mixing device, or a combination thereof. When the target composition is a coating composition or a part thereof, the receiving device can comprise one or more containers, a subsequent mixing device, one or more end use devices such as spray devices or rolling coating devices, one or more measurement devices, one or more storage devices such as tanks or trucks, or a combination thereof.

In addition to the wet color data, the specimen property values can further comprise specimen pH data, specimen viscosity data, specimen opacity data, specimen hiding data, specimen flop data, specimen texture data, specimen sparkle data, specimen resistivity data, specimen solids data, specimen density data, specimen volatile organic compound (VOC) data, or a combination thereof. The target property values can further comprise target pH characteristics, target viscosity characteristics, target opacity characteristics, target hiding characteristics, target flop characteristics, target texture characteristics, target sparkle characteristics, target resistivity characteristics, target solids characteristics, target density characteristics, target volatile organic compound (VOC) characteristics of the target composition, or a combination thereof. The aforementioned target property values, or a part thereof, can be referred to as “key adjustable properties” (KAP), hereafter. Based on compositions, one or more of the target property values can be predetermined as KAP. In one example, pH, viscosity and color can be determined as KAP for a waterborne coating composition. In another example, viscosity, hiding and color can be determined as KAP for a coating composition. In yet another example, VOC, viscosity and color can be determined as KAP for a coating composition. In yet another example, color can be determined as KAP. The target property values can be stored in a property database. The specimen property values can also be stored in the property database or a separate database, once obtained. The pH data can be related to waterborne compositions, such as waterborne coating compositions.

Some of the specimen property values and some of the target property values can only be obtained or measured when the target composition or the specimen is in a wet state such as viscosity values of a liquid or in a dry state such as or hardness values of a dry coating, respectively. Some of the property values can be obtained or measured at both a wet state and a dry state, such as color data, hiding data, etc. The dry values and the wet values can be the same or different. Typically, wet color data can be different from dry color data for a given coating composition. The wet color data and the dry color data can be correlated via a wet-dry color correlation that correlates individual wet color characteristics and individual dry color characteristics of individual compositions.

The wet color data can be compared to the wet target color characteristics directly, to the dry target color characteristics via a wet-dry color correlation, or a combination thereof. Other specimen property values such as specimen pH data, specimen viscosity data, specimen opacity data, specimen hiding data, specimen flop data, specimen texture data, specimen sparkle data, specimen resistivity data, specimen solids data, specimen density data, specimen volatile organic compound (VOC) data, or a combination thereof, can be compared to the corresponding target property values, respectively. The predetermined individual tolerance range can be determined by those skilled in the art. In one example, a pH tolerance range can be set at ±(0% to 5% variance). In another example, a viscosity tolerance range can be set at ±(0% to 10% variance). In yet another example, a specimen resistivity tolerance range can be set at ±(0% to 5% variance).

The wet color data of the specimen can also be compared to specimen wet color data obtained from previous batches of the targeting composition.

The process can further comprise the step of:

A4) repeating the steps A1), A2), A3), and A4) for subsequent specimen property values of one or more subsequent specimens of the one or more subsequent intermediate mixtures until each of the subsequent specimen property values is within the predetermined individual tolerance range.

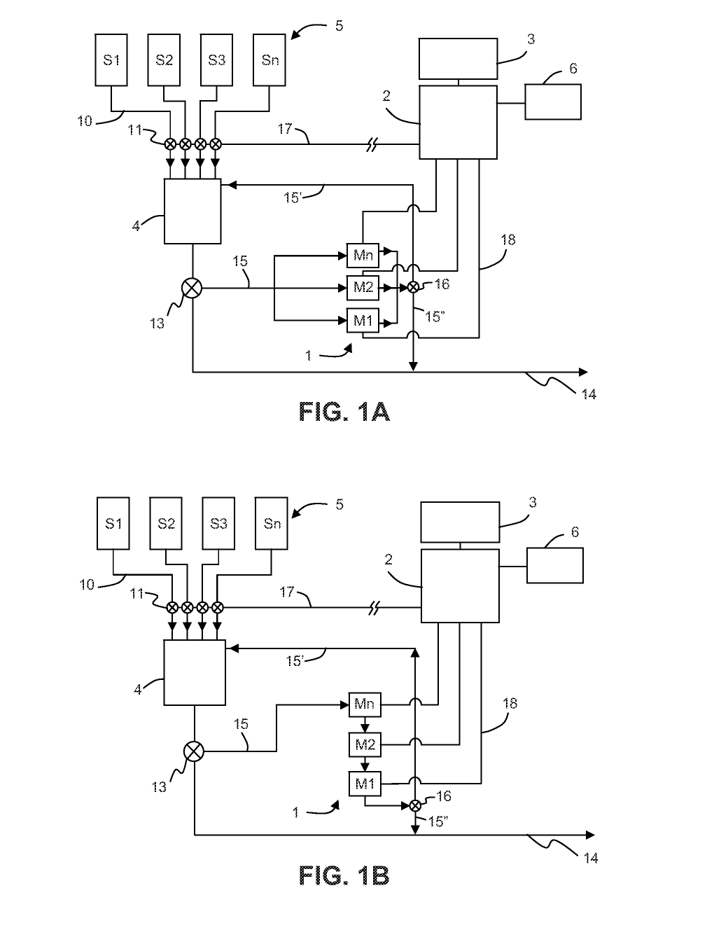

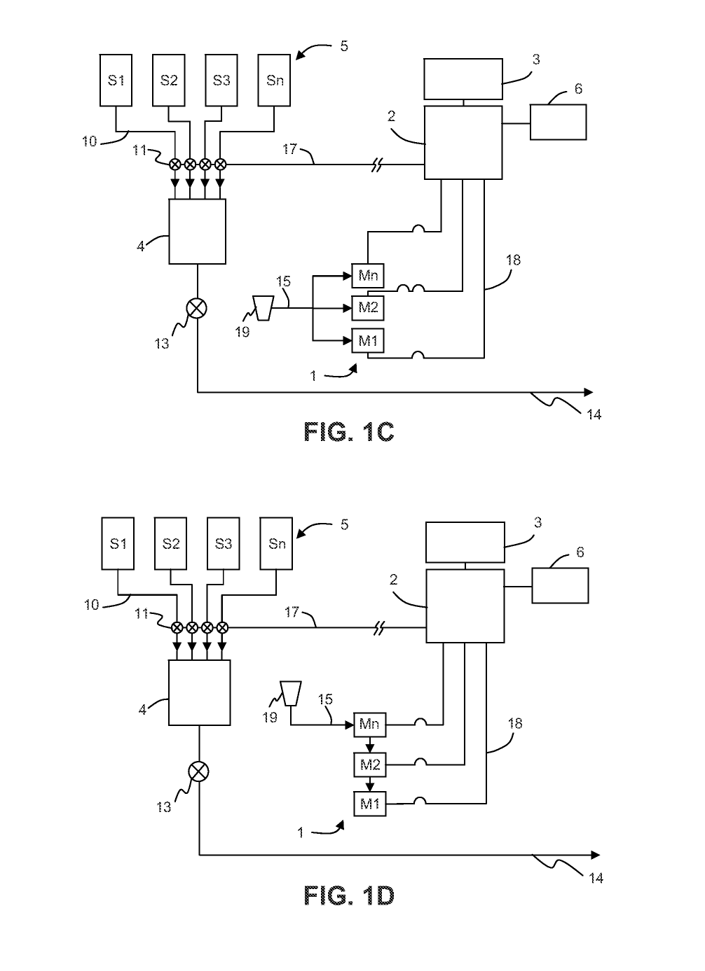

The process can be implemented using systems shown in FIG. 1 (FIG. 1A-FIG. 1D) and disclosed hereafter.

The step A2) of the process disclosed herein can comprise the steps of:

A5) generating at least one specimen image comprising specimen color display values based on the wet color data; and

A6) displaying the specimen image based on the specimen color display values on one or more display devices.

The step A2) can further comprise the steps of:

A7) comparing the specimen image to one or more samples of the target composition, one or more target images of the target composition, or a combination thereof; and optionally, comparing the wet color data to the target color characteristics;

wherein the one or more target images comprise target display values based on the wet target color characteristics or the dry target color characteristics.

In the aforementioned process, the one or more samples of the target composition can be selected from a wet sample of the target composition, a simulated wet sample of the target composition, a dry sample of the target composition, a simulated dry sample of the target composition, or a combination thereof. The simulated wet sample can be produced from the same or different materials or compositions. In one example, a simulated wet coating sample can be produced from polymers the same or different from the coating composition, such as plastics having pigments. In another example, a dry sample can be a dried coating formed from the target coating composition over a substrate. In yet another example, a simulated dry coating sample can be formed from the same or different compositions or materials, such as plastics having pigments or printing with inks. The one or more samples of the target composition can have the same or visually indistinguishable color characteristics as that of the target composition. The one or more samples of the target composition can also have color characteristics within a predetermined color tolerance range compared to that of the target composition.

The specimen color display values can comprise R,G,B values based on the wet color data. Typically, color characteristics can comprise color data values selected from L,a,b color values, L*,a*,b* color values, XYZ color values, L,C,h color values, spectral reflectance values, light absorption (K) and scattering (S) values (also known as “K,S values”), or a combination thereof. The color data values can be obtained at one or more illumination angles, one or more viewing angles, or a combination thereof, as described herein. The color data values can be converted to color display values, such as R,G,B values, for displaying on a display device that is capable of displaying R,G,B values, such as digital display devices, for example, TVs, monitors, computer screens, smart phone screens, or a combination thereof. The color display values can also be adjusted for each individual display device for improved representation of the color of the specimen. The target display values can also comprise R,G,B values based on the wet target color characteristics or the dry target color characteristics.

The wet target color characteristics and the dry target color characteristics can be correlated with a wet-dry color correlation that correlates individual wet color characteristics and individual dry color characteristics of individual compositions. Such wet-dry correlation can be a function or based on measurements of previous batches, multiple samples of the target composition, and also be interpolation or extrapolate based on previous measurements. In one example, a mathematic curve fitting can be used to interpolation or extrapolate color characteristics.

The process can further comprise the step of:

A5a) generating a dry specimen image comprising dry color display values based on dry specimen color data derived from the wet color data according to the wet-dry color correlation; and

A6a) displaying the dry specimen image based on the dry color display values on one or more display devices.

The dry specimen image can be displayed on the same or different display devices as the aforementioned specimen or the target images.

The one or more individual components and the one or more adjustment components can comprise one or more acids, one or more bases, one or more dyes, one or more pigments, one or more effect pigments, one or more solvents, one or more polymers, one or more film forming polymers, one or more additives, or a combination thereof. The subsequent intermediate mixture can be produced by mixing the one or more individual components, the one or more adjustment components, or a combination thereof, into the intermediate mixture, manually or automatically, based on one or more component adjustment functions. The adjustment function can comprise a linear adjustment function, a non-linear adjust function, or a combination thereof. The adjustment functions can be established based on calculations, data modeling, empirical measurements of a plurality of samples, or a combination thereof. In one example, pH adjustments can be based on calculations according to pH variations away from the target pH value, the volume of the intermediate mixture, and the strength of the acid or base components that is to be used for adjustment. In another example, color adjustments can be based on data modeling using available measurements of previously measured samples. Each of the subsequent intermediate mixtures can also be produced based on an adjustment formula. In one example, an adjustment formula for adjusting color of a coating composition can be produced based on calculations, data modeling, empirical measurements of a plurality of samples, or a combination thereof. In a further example, color adjustment and an adjustment formula can be produced by using ColorNet® system available from E. I. du Pont de Nemours and Company, Wilmington, Del., USA, under registered trademark. The ingredients or components according to the adjustment formula can be added to the intermediate mixture.

The target viscosity can typically be a range of specification limits. Since it is easier to reduce viscosity, in one example, following equation can be used to target an adjusted viscosity closer to an upper specification limit:

Adjusted viscosity=0.666×USL+0.333×LSL

wherein: USL=Upper Specification Limit and LSL=Lower Specification Limit. Empirical functions or equations can be developed for adjusting viscosity for different compositions. Solvents, solid components, or a combination thereof, can be used for adjusting viscosity. One or more solvents can used to reduce viscosity. One or more solid components can be used to increase viscosity. Viscosity reduction curves can be linear or non-linear depending solvents and compositions. Other factors, such as intermolecular forces, surface tension, hydrogen bonding, solubility parameters, and polarity can be considered in viscosity adjustment. In another example, Minitab© software, under registered trademark of Minitab, Inc., State College, Pa., USA, can be used to analyze the effects of viscosity, product and reducer amount on data collected from testing samples. Regression tools can be used to develop correlations for viscosity and the factors considered.

One or more of the specimen property values can be obtained by a wet measurement process comprising the steps of:

B1) producing a thin film of the first specimen;

B2) providing illumination towards the thin film at one or more illumination angles; and

B3) measuring the at least one of the specimen property values at one or more viewing angles under the illumination, wherein the at least one of the specimen property values comprise reflectance data of the illumination reflected by a surface of the thin film, transmittance data of the illumination through the thin film, or a combination thereof.

In one example, some specimen property values, such as color, opacity or hiding, can comprise reflectance data, transmittance data, or a combination thereof. In another example, wet color data can comprise spectral transmittance data, spectral reflectance data, or a combination thereof.

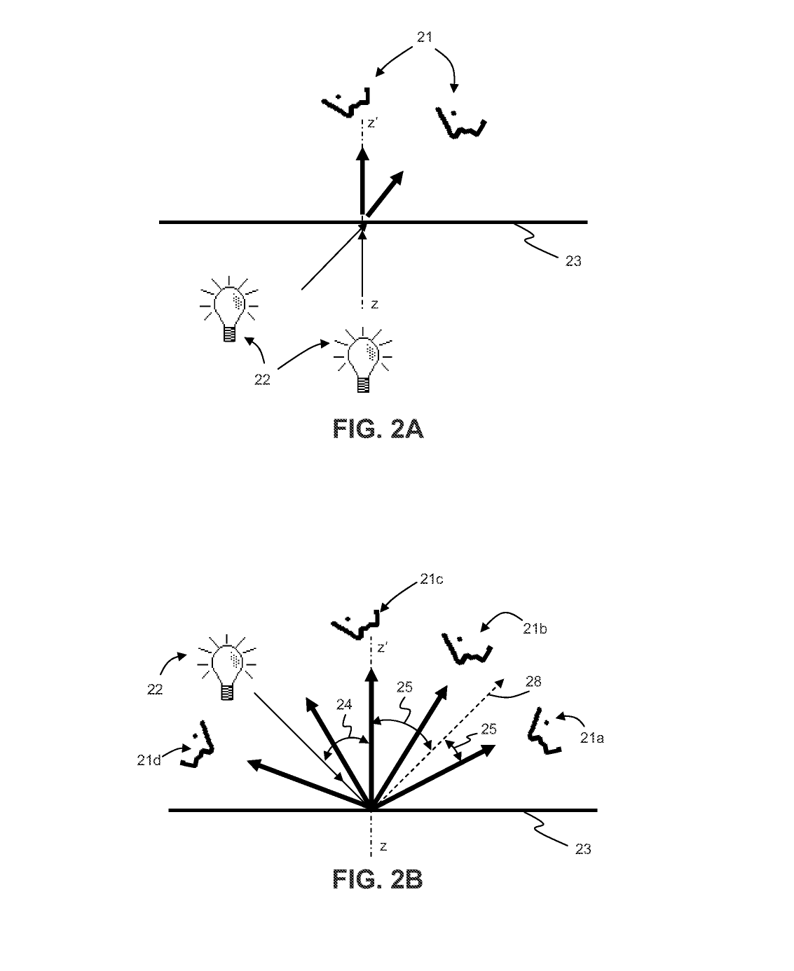

The specimen property values can comprise transmittance data of an illumination through the target composition and can be viewed or measured by positioning one or more illumination sources (22) at one side of a thin film of the target composition (23) and viewing or measuring the transmittance data through the thin film from the other side of the thin film at one or more viewing angles (21) as schematically illustrated in FIG. 2A. Specimen property values can also comprise reflectance data of an illumination reflected by a surface of a specimen of the target composition and can be viewed or measured by positioning one or more illumination sources (22) at one side of the thin film of target composition (23) and viewing or measuring the reflectance data on the same side of the target composition at one or more viewing angles (21a, 21b, 21c and 21d) as schematically illustrated in FIG. 2B. For coatings formed from coating compositions, specimen property values, such as color or appearance, can be measured at one or more illumination angles, one or more viewing angles, or a combination thereof. A standard procedure can include ones described in ASTM E-2194, herein incorporated in by reference. An illumination source (22), such as a light bulb or sun light, can be positioned at one or more illumination angles (24) that is measured from the normal (z-z′) of the surface, such as the surface of the thin film of the target composition (23). A number of viewing angles can be suitable, such as, 1) near aspecular angles, such as (21a) and (21b), that are the viewing angles in a range of from ±15° to ±25° from the specular reflection (28) of the illumination; 2) mid aspecular angles (21c), that are the viewing angles about 45° from the specular reflection (28) of the illumination; and 3) far aspecular angles (21d) (also known as flop angles), that are the viewing angles in a range of from 75° to 110° from the specular reflection (28) of the illumination. For a coating, especially for a coating having effect pigments, color can appear to be brighter at near aspecular angles and darker at far aspecular angles.

The one or more of the specimen property values obtained by the wet measurement process can be selected from wet color data of a specimen such as the first specimen, specimen opacity data, specimen hiding data, specimen flop data, specimen texture data, specimen sparkle data, or a combination thereof. Except specifically stated, the specimen property values can be obtained from the wet specimen, the dry specimen, or a combination thereof.

The thin film can have a film thickness in a range of from 0.1 micrometer to 4000 micrometers in one example, 0.1 micrometer to 2000 micrometers in another example, 0.1 micrometer to 1500 micrometers in another example, 0.1 micrometer to 1000 micrometers in yet another example, 0.1 micrometer to 800 micrometers in yet another example, 0.1 micrometer to 600 micrometers in yet another example, 0.1 micrometer to 400 micrometers in yet another example, 0.1 micrometer to 200 micrometers in yet another example, 0.1 micrometer to 100 micrometers in yet another example, and 0.1 micrometer to 50 micrometers in a further example. The thin film can be produced from a laminar flow of the first or any subsequent specimen, a static film of the first or any subsequent specimen, or a combination thereof. The laminar flow of the specimen refers to a flow of the specimen that is flowing or moving continuously or incrementally during the measurement. The static film refers to a volume of the specimen that remains still during the measurement.

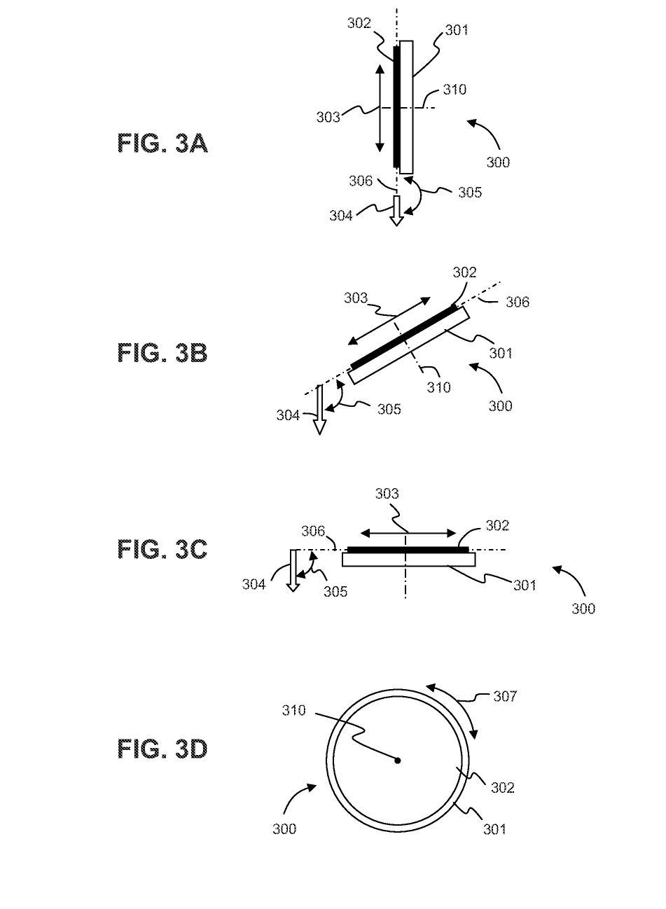

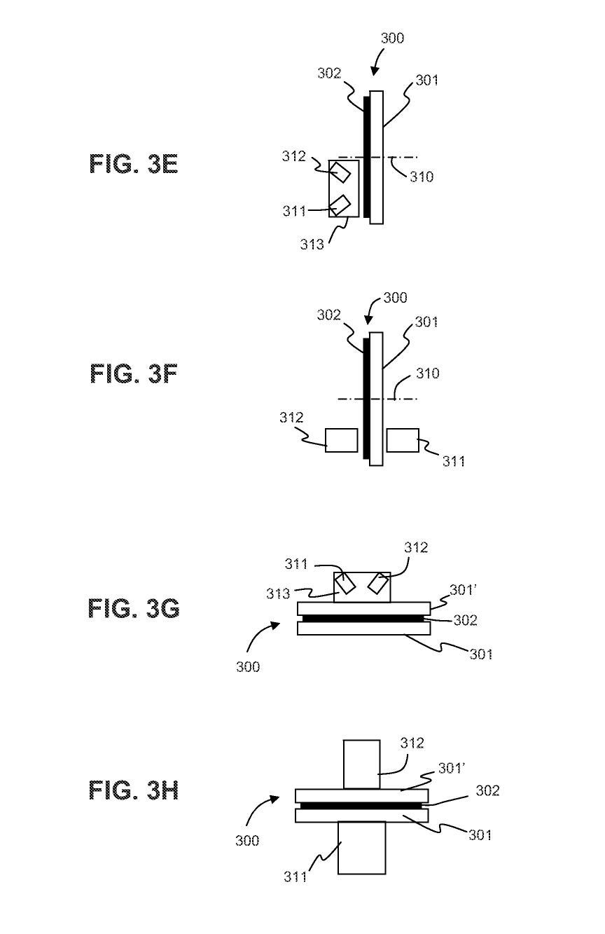

The spinning disk device disclosed on German Patent No.: DT 25 25 701 (also referred to as DE 25 25 701 (A1)), issued to Wilhelm Langer on Dec. 23, 1976, or similar or modified devices, can be suitable for producing a laminar flow of the specimen. As understood by those skilled in the art, the spinning disk in the aforementioned device needs to be transparent for measuring transmittance data. The flow cell devices disclosed in U.S. Pat. Nos. 7,684,045, 6,888,636, 7,027,147, 6,867,861, 7,423,755, 7,248,350, 7,542,143, 7,477,394, or similar or modified devices, can also be suitable. The thin film (302) can be produced by flowing the specimen at one of flow directions (303) resulting in a film plane (306) that can have a film plane angle (305) in a range of from 0° to 180° from the direction of gravity (304) (FIG. 3A-3C), i.e, parallel (FIG. 3A), perpendicular (FIG. 3C), or any angle in between (FIG. 2B), relative to the direction of gravity (304). The specimen can also flow or move in rotational directions (307) about a rotational axis (310) (FIG. 3D). The thin film (302) can be over a thin film substrate (301), such as the disk in the spinning disk device, a part of flow cell wall in a flow cell device, or a test panel.

Other devices or instruments, such as coating application devices, for example, a spray gun, a paint roller, a paint brush, a paint drawdown blade, a dipping coating device, an electrocoating device, or a combination thereof, can be suitable for producing the static film of the specimen over a substrate.

In one example, wet color data or hiding dada can be obtained from a laminar flow of the specimen using a spinning disk device, a flow cell device, or a combination thereof, or from a static film drawn down on a substrate. In another example, sparkle data can be obtained from a static film of the specimen.

The reflectance data can be obtained using an illumination device (311) to provide illumination at one or more illumination angles and a detection device (312) to detect or record the reflection reflected by a surface of the specimen (FIG. 3E and FIG. 3G). The transmittance data can be obtained using an illumination device (311) to provide illumination at one or more illumination angles and a detection device (312) to detect or record the transmittance through a thin film of the specimen (FIG. 3F and FIG. 3H).

At least one of the specimen property values can be a predicted property value based on types and amounts of individual components mixed into the intermediate mixture and optionally mixing parameters of a mixing process that produces the intermediate mixture. Examples of specimen property values can include color, hiding, viscosity, sag, appearance, and other property values. The predicted property value can be obtained by a prediction process comprising the steps of:

C1) entering input data into a trained prediction model; and

C2) producing the at least one of the specimen property values from the trained prediction model based on the input data;

wherein the input data comprise the types and the amounts of individual components and optionally the mixing parameters of the mixing process.

The input data can comprise a formula of the target composition, such as a formula for a coating composition, or a color formula. In one example, the Kubelka-Monk model can be suitable as the trained prediction model for predicting color properties based on types and amounts of individual components of the target composition, such as a coating composition. The mixing parameters can include time of mixing, speed of mixing rotor, mixing temperature, mixing humidity, or a combination thereof. The trained prediction model can be trained using formulas, mixing parameters, or a combination thereof, of a plurality of compositions. The artificial neural network prediction process and model disclosed in US Patent Publication No.: 2008/0010027 (A1) and U.S. Pat. No. 5,119,468 can be suitable. Other models or processes, such as color prediction models that predict color of a composition based on light absorption properties of components of the composition, can also be suitable.

The target composition can comprise liquid, such as water, one or more organic solvents, one or more inorganic solvents, one or more non-solvent liquid components, or a combination thereof. The target composition can be wet containing all or most of the liquid when it is produced. The target composition can comprise in a range of from 1% to 99% of the liquid. The target composition can become dry by losing some or all of the liquid or by reacting some or all of the liquid via curing such as chemical curing, radiation curing, thermal curing, or a combination thereof, into solids.

Each of the one or more subsequent intermediate mixtures can be produced based on the observed difference property values by adjusting appropriate components related to the individual property values. For adjusting color, one or more components such as pigment components, effect pigment components, dye components, or a combination thereof, can be mixed into the intermediate mixture to produce a subsequent intermediate mixture.

As disclosed herein, the target composition can be a coating composition. The coating composition can be a clearcoat coating composition or a color coat coating composition. A clearcoat can be free from pigments. A clear coat can also comprise one or more pigments that have the same or similar optical properties of a binder component of the clearcoat, such as silicon pigments that have the same or similar refraction or reflection indexes as that of the binder component. The wet color data can be used to determine whether the clearcoat is within a predetermined color tolerance range. The coating composition can be a primer, a basecoat, a topcoat, or a multi-functional coating functions such as a combined primer and basecoat, a combined basecoat and topcoat, or a combined primer/basecoat/topcoat. The coating composition can comprise one or more dyes, one or more pigments, one or more effect pigments, or a combination thereof. The coating composition can be useful for automotive OEM (original equipment manufacturer) for producing vehicles, for refinish vehicles, or a combination thereof. The coating composition can be one package (1K), latex, or two package (2K) composition, and can be chemical curable or irradiation such as UV curable. The coating composition can further be waterborne or solvent borne.

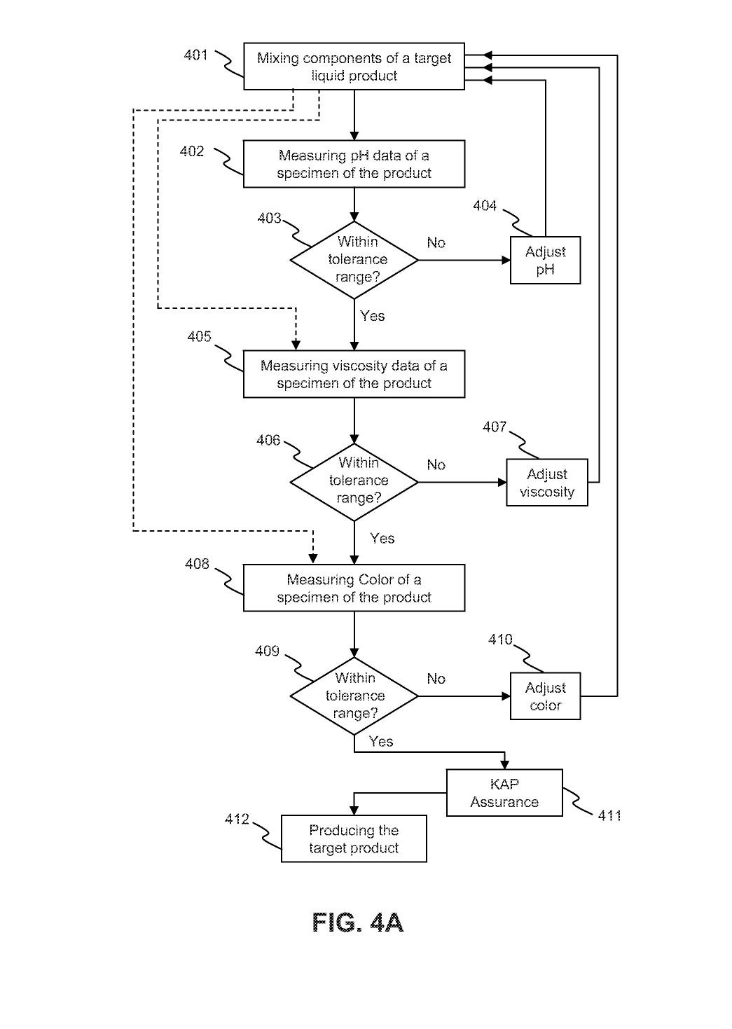

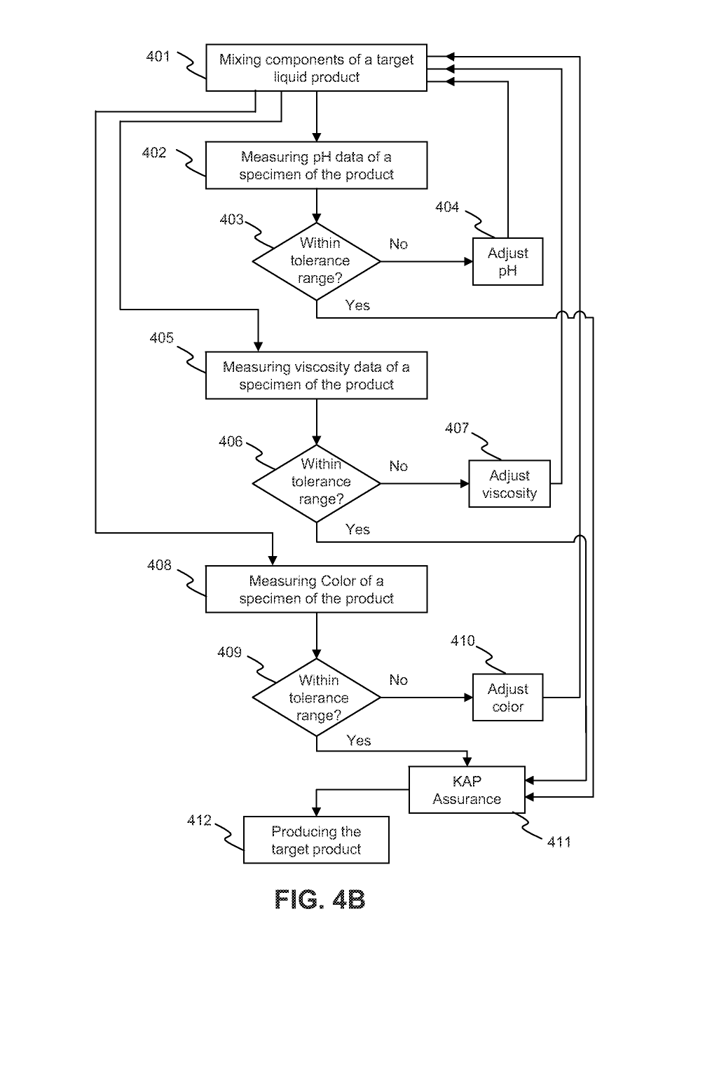

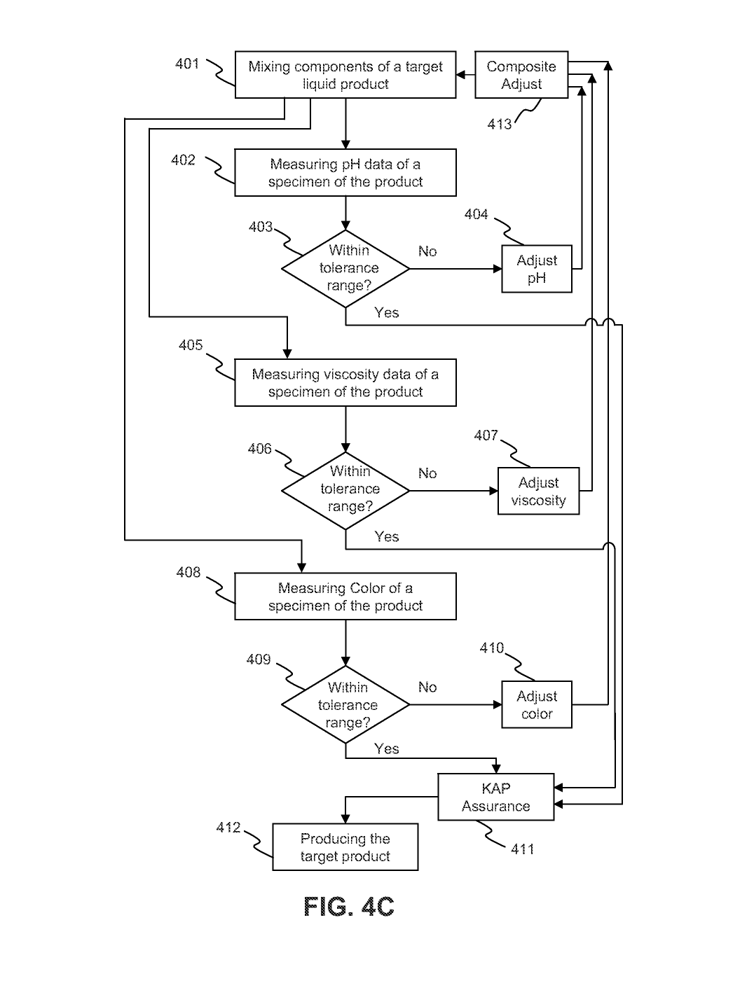

In the process disclosed herein, the target composition can be produced in a continuous process, a semi-continuous process, or a batch process. The specimen property values can be obtained continuously, discretely at one or more predetermined time points, discretely at one or more random time points, or a combination thereof. The specimen property values can be obtained sequentially or simultaneously (FIGS. 4A, 4B and 4C). The intermediate mixture can be produced by mixing components based on a formula of the target composition. The adjustment can be made separately (FIGS. 4A and 4B) with individual components specific for individual property values or with a composite adjustment mixture that can adjust a plurality of property values (FIG. 4C). The target composition or any of the intermediate mixtures can be automatically mixed based on a formula and controlled by a computer, manually mixed based on a formula or an input from a user, or a combination thereof.

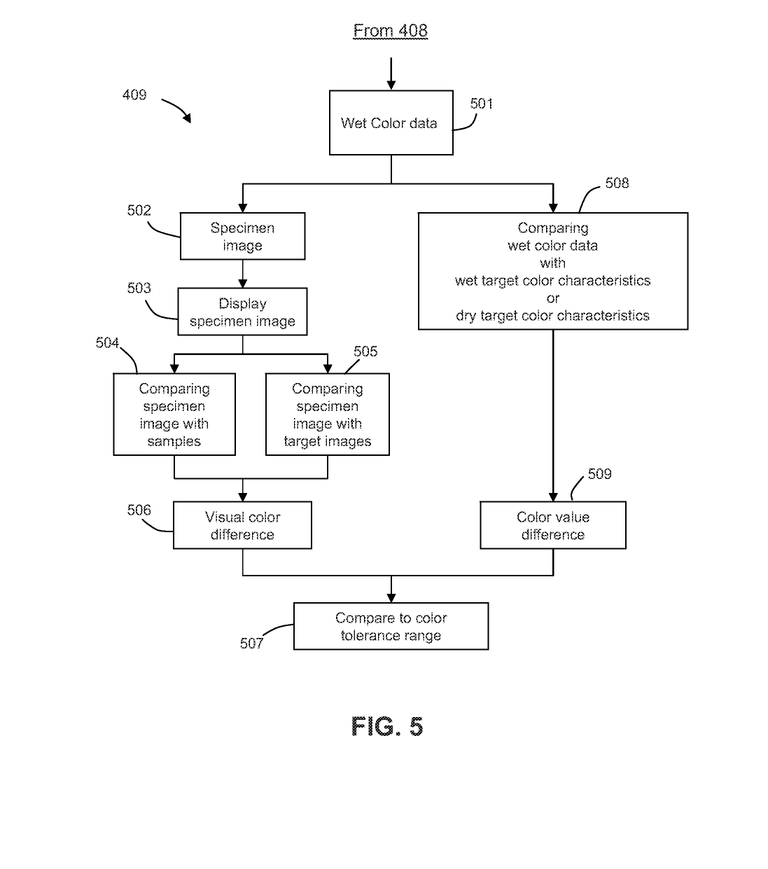

Comparing color data can be done via visual inspection or via color data comparison (FIG. 5). The color difference can be calculated using color difference calculation methods selected from ΔE, ΔE*_{ab}, ΔE*₉₄, or other color difference definitions or equations, such as the color differences (ΔE) based on BFD, CMC, CIE 1976, CIE 2000 (also referred to as CIEDE 2000), or any other color difference definitions or equations known to or developed by those skilled in the art.

Difference in flop (ΔF) can be generated based on a function that calculates the difference between a specimen flop value (F_{Spec}) and the flop characteristic of the target composition (F_{Target}). The flop difference can be defined by the following function: ΔF=ƒ(F_{Spec}, F_{Target}).

Differences in sparkle (ΔS_{g}) can be defined as: ΔS_{g}=ƒ(S_{g-Target}, S_{g-Spec}) wherein, S_{g-Target} and S_{g-Spec} are sparkle characteristics of the target composition and specimen sparkle values, respectively. Sparkle values and characteristics can be obtained from commercial instruments, such as BYK-mac available from BYK-Gardner USA, Columbia, Md., USA.

Coarseness can also be measured from specimens of a coating composition. Differences in coarseness can be generated. Aforementioned BYK-mac can also be used to measure coarseness of coatings.

Smoothness or roughness of the specimen surface can be measured using an imaging device, a 3D imaging device, or a topographic imaging or measurement device and can be measured using wet specimen, partially dried specimen or dry specimen.

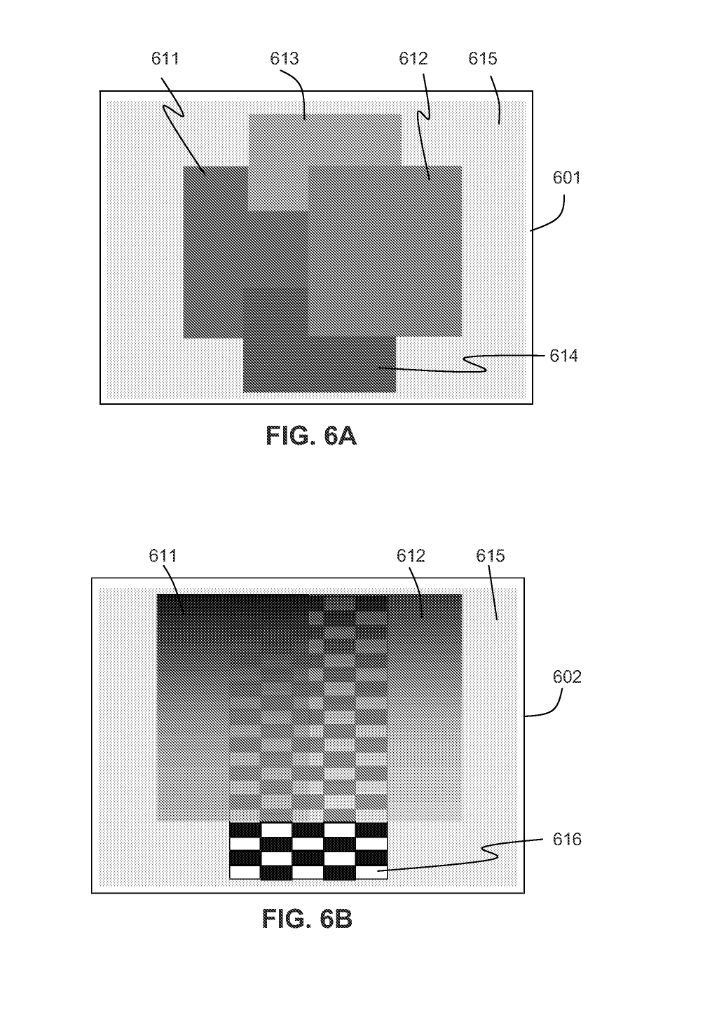

The visual inspection can be done by displaying at least one of the specimen images (611) interlaced with one or more target images on a digital display device, such as a laptop screen, a smart phone screen, a touch screen, and visually comparing the images by a user. The one or more target images can comprise a target image comprising color display values based on the target color characteristics (612), a second target image comprising color display values based on a lower tolerance limit of the target color characteristics (613), a third target image comprising color display values based on an upper tolerance limit of the target color characteristics (614), or a combination thereof (FIG. 6A). The images can be displayed in a specimen display area (601) over a background color (615) appropriate for the visual comparison. The interlaced display and the background color can improve visual comparison.

The hiding data can be displayed on a digital display device, wherein at least one of the specimen images (611) and at least one of the target images (612) can be displayed side-by-side over a hiding mark (616). The hiding mark can typically comprise high contrast patterns, such as black-and-white patterns, red-and-grey patterns, or any other high contrast patterns suitable for assessing hiding. The images can be displayed in a specimen display area (602) over a background color (615) appropriate for the visual comparison (FIG. 6B). The hiding data can also be compared by calculating the differences between the specimen hiding data and the target hiding characteristics. The calculation can be done by a user or by using a computer and a computing program product.

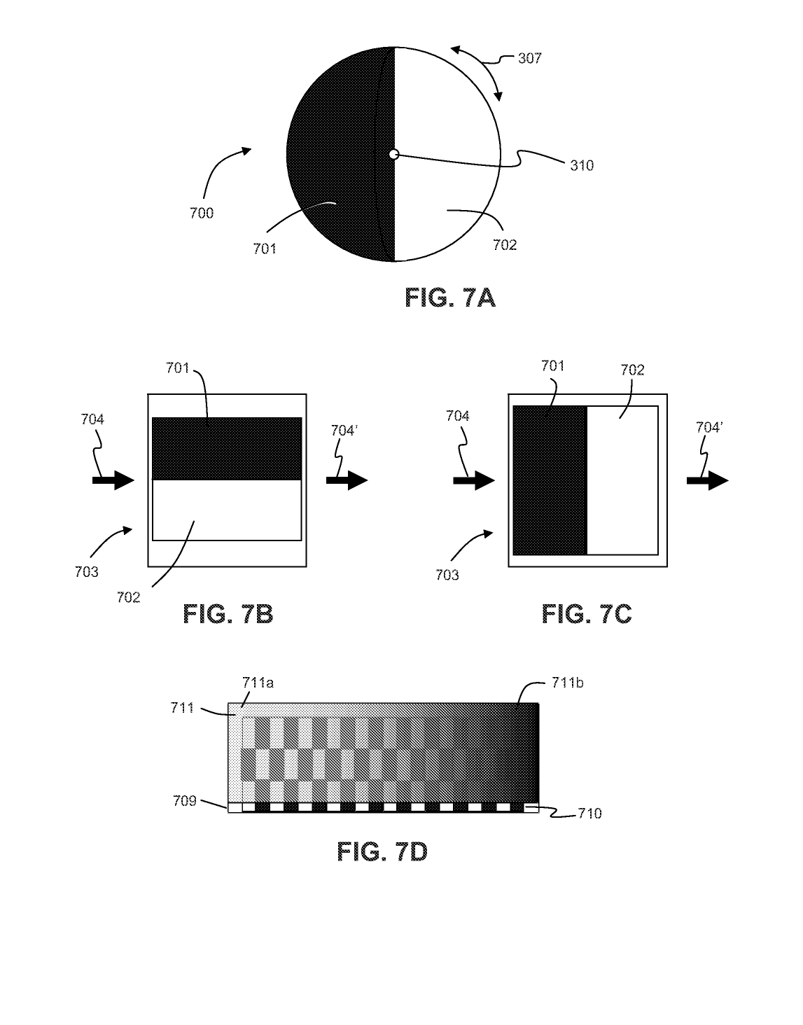

The hiding data can be obtained by measuring reflectance of the thin film of the specimen over a substrate having high contrast patterns. In one example, a disk (700) having a black-and-white pattern, half black (701) and half white (702), can be used. The disk can rotate at one of the rotating directions (307) alone its rotation axis (310) with a thin film of the specimen (not shown) over the disk (FIG. 7A). An illumination and a detection device can be positioned to measure reflectance of the thin film at predetermined illumination and viewing angles. The measurements can be synchronized with the rotation of the disk so the reflectance including lightness values, color values, or a combination thereof, over the black background (black reflectance values) and over the white background (white reflectance values) can be contained. The ratio of the lightness values extracted from the black reflectance values and the white reflectance values, respectively, or the color difference (ΔE*) measured over the black and white backgrounds can represent hiding property of the specimen. In another example, a flow cell device (703) can have a high contrast pattern, such as the black (701) and the white (702) arranged parallel to the direction of flow (FIG. 7B) or at an angle such as perpendicular to the direction of the flow (FIG. 7C). A specimen can flow into (704) and out of (704′) the flow cell device with the white hiding values and black hiding values measured. In yet another example, a specimen can be coated onto a substrate (709) to form a thin film (711) over a hiding mark (710) with film thickness varying from low thickness at a thin end (711a) to a high thickness at a thick end (711b) of the coated substrate (FIG. 7D). White hiding values and black hiding values can be measured at different film thickness levels to generate the hiding data. The hiding data can be wet hiding data measured when the thin film is still wet, dry hiding data when the thin film is dry, or a combination thereof. The hiding data can be used for displaying on digital display devices. Film thickness can also be measured. The hiding data can comprise film thickness data.

This disclosure is further directed to a system for producing a target composition having one or more target property values. The system can comprise:

(A) one or more liquid measuring devices (1) for measuring specimen property values of a specimen of the target composition, the one or more liquid measuring devices comprise a wet color measuring device for obtaining wet color data of the specimen;

(B) a first computing device (2);

(C) one or more display devices (3), wherein the first computing device is functionally coupled to the one or more liquid measuring devices, the one or more display devices, or a combination thereof; and

(D) one or more digital data storage devices containing a computing program product functionally coupled to the first computing device, the computing program product comprises computing program codes for:

D1) receiving the specimen property values from the one or more liquid measuring devices;

D2) generating at least one specimen image comprising specimen color display values based on the wet color data; and

D3) displaying the at least one specimen image having the specimen color display values on the one or more display devices.

In the system disclosed herein, the computing program product can further comprise computing program codes for:

D4) comparing the specimen property values with one or more target property values of the target composition, wherein the target property values comprise wet target color characteristics of the target composition, dry target color characteristics of the target composition, or a combination thereof; and

D5) generating an output signal to output the target composition if each of the specimen property values is within a predetermined individual tolerance range, or generating an adjustment formula for producing a subsequent mixture of the target composition if at least one of the individual property values is not within the predetermined individual tolerance range, the adjustment formula comprises adjustment data of one or more individual components of the target composition, one or more adjustment components, or a combination thereof.

The computing program product can further comprise computing program codes for generating a termination signal for terminating the operation of the system or generating a request for input signal for obtaining input from a user on how to continue the operation of the system.

The liquid measuring devices (1), the first computing device (2), the display devices (3), or a combination thereof can be functionally coupled via wired or wireless connections. The first computing device can further comprise or functionally coupled to one or more data input devices, data output devices, or a combination thereof. The computing device can also be a built-in computing device in one or more of the liquid measuring devices. The computing device, one or more input devices and the display devices can also be combined as one device, such as laptop computer, a smart phone, a tablet computer, or a measuring device having a display thereon.

The system can further comprise:

(E) at least one mixing device (4) for mixing one or more individual components of the target composition; and

(F) one or more supply devices (5) functionally coupled to the mixing device for supplying the one or more individual components to the mixing device.

The mixing device (4) can be coupled to the supply devices (5) via one or more supply lines (10) that can be further coupled to one or more supply control devices (11) (FIG. 1A-1D).

The liquid measuring devices can be in an in-line configuration wherein one or more specimen input lines (15), such as pipes, tubes, or other types of connections, connect the mixing device and the liquid measuring devices for delivering the specimen from the mixing device to the liquid measuring devices (FIGS. 1A and 1B). In this in-line configuration, the system can further comprise one or more specimen output lines (15″) to deliver the spent specimen or excess specimen to the system's product output line (14), a specimen return line (15′) to return the spent specimen or excess specimen to the mixing device, or a combination thereof. The spent specimen or excess specimen can also be simply drained out. The system can further comprise one or more specimen input control valves (13), one or more specimen output control valves (16), or a combination thereof (FIGS. 1A and 1B). The liquid measuring devices can be in an off-line, at-line or stand-alone configuration wherein the specimen can be delivered via one or more specimen transport receivers (19) into the specimen input lines (15) (FIGS. 1C and 1D). Each of the liquid measuring devices can also have individual specimen transport receiver (19) and specimen input line (15) connected to each of the devices. For example, there can be 3 individual specimen transport receivers (19) each connected to one of the devices. The liquid measuring devices can be positioned near or away from the mixing devices, such as next to the mixing device, in a room next to the mixing device, or in a building away from the mixing device.

The one or more liquid measuring devices can be configured to receive the specimen via one or more specimen delivery devices. The specimen delivery devices can comprise the aforementioned one or more specimen input lines (15) directly linking the mixing device with at least one of the liquid measuring devices, an aforementioned specimen transport receivers (19) for receiving the specimen into the one or more liquid measuring devices, or a combination thereof.

The system can further comprise:

(G) a second computing device functionally coupled to the one or more supply devices, and optionally to the mixing device, to control the one or more supply devices for supplying the one or more individual components to the mixing device according to a mixing input;

wherein the first computing device and the second computing device can be the same or different.

The second computing device can be coupled to the supply control devices (11) via one or more supply control connections (17) that can be wired, wireless, or a combination thereof. The liquid measuring devices can be coupled to the first or the second computing devices via one or more specimen data connections (18). In one example, the first and the second computing devices can be separate computers. The separate computers can be coupled via one or more data connections. In another example, the first and the second computing devices can be the same computer. The supply devices can also be controlled by an operator with or without the second computing device. The mixing input can be selected from one or more inputs from an operator, one or more data inputs based on a formulation or a modified formulation, or a combination thereof.

In the system disclosed herein, the computer program product can further comprise computing program codes for:

D6) providing the adjustment formula to the second computing device for controlling the one or more supply devices to supply one or more components to the mixing device according to the adjustment formula; and

D7) repeating the steps of (D1) through (D7) until each of the individual property values is within the predetermined individual tolerance range.

The system can further comprise a color system functionally coupled to any of the computing devices or an access connection data for accessing the color system, such as the aforementioned ColorNet® system. The access connection data can comprise a link to access the color system through a network connection selected from a wired connection, a wireless connection, or a combination thereof, to a remote computer server when the color system or a part thereof resides in the remote computer server. The access connection data can further comprise computing program codes for an authentication process such as requiring a user ID and password, or other authentication or security measurements.

The system can comprise one or more subsequent display devices. The modified formula and the images can be displayed on the display devices or any of the subsequent display devices. Any of the display devices and the computing device can be functionally coupled via wired connections, wireless connections, or a combination thereof. The specimen images can be displayed as solid color images, realistic images, HDR (high dynamic range) images, realistic images rendered with BRDF (bidirectional reflectance distribution function), or a combination thereof. The process described in U.S. Pat. No. 7,991,596 for generating and display digital images via BRDF can also be suitable. The realistic images, the HDR images and the BRDF images can be particularly suitable for displaying specimen images from target compositions that comprise effect pigments.

The computer program product can further comprise computing program codes for:

D6a) displaying the adjustment formula and the specimen image on the one or more display devices prior to the step D6); and

D6b) receiving an operation input selected from: a) proceeding to the step D6), b) terminating mixing operations of the system, or c) modifying the adjustment formula.

The computing program product can further comprise computing program codes for generating or retrieving one or more target images and displaying the target images on the one or more display devices. The target images can comprise target color display values based on the wet target color characteristics or the dry target color characteristics. The target color characteristics can be obtained through modeling, calculations, retrieving existing data from one or more databases accessible from the computing device, actual measurements of test panels, actual measuring of articles such as vehicles, or a combination thereof.

The wet color measuring device can comprise:

E1) a thin film device (300) for producing a thin film (302) of the specimen having a film thickness in a range of from 1 micrometer to 2000 micrometers;

E2) an illumination device (311) for providing illumination towards the thin film at one or more illumination angles; and

E3) a detection device (312) for measuring the at least one of the specimen property values at one or more viewing angles under the illumination, wherein the at least one of the specimen property values comprise reflectance data of the illumination reflected by a surface of the thin film, transmittance data of the illumination through the thin film, or a combination thereof.

The illumination device (311) and the detection device (312) can be configured into one specimen measurement device (313). Color measuring devices such as a colorimeter, a spectrophotometer, a goniospectrophotometer, or a combination thereof, can be suitable. Any suitable colorimeter or spectrophotometer, such as Model SP64 manufactured by X-Rite, Grandville, Mich. can be used. A goniospectrophotometer is also known as multi-angle spectrophotometer. Any suitable Goniospectrophotometers, such as Model MA68II from X-Rite, Grandville, Mich., or the ones provided by Murakami Color Research Laboratory, Tokyo, Japan, or by IsoColor Inc., Carlstadt, N.J., USA, can be used. Commercial instruments, such as BYK-mac available from BYK-Gardner USA, Columbia, Md., USA, that can measure color and sparkle, can also be suitable.

The thin film device (300) can comprise a substrate (301) for positioning the thin film (302). The thin film device can be configured to position the thin film at any angles (305) in relation to the direction of gravity (304) as illustrated in FIG. 3A-3D. The thin film device can be selected from: a spinning disk device, a flow cell device, a coating application device, or a combination thereof. The spinning disk device can comprise a circular planar disk having a first and a second disk surfaces on the opposite sides of the circular planar disk and a rotational axis (310) perpendicular to the disk surfaces for providing rotation. The thin film can be produced on one of the disk surfaces. The flow cell device can have a second wall (301′) that can define the thickness of the thin film together with the film substrate (301) when assembled together. The aforementioned devices can be suitable. The film substrate, the second wall, or a combination thereof, can be transparent or opaque. For obtaining transmittance data, the film substrate (301) and the second wall (301′), when present, are transparent. The thin film device can comprise a film thickness control device for producing the film having a film thickness in the aforementioned ranges.

The first computing device (2) can be a portable computing device functionally coupled to one or more liquid measuring devices via wireless connections. The computer program product or a part thereof can be functionally accessed from the first computing device, a remote computing device, or a combination thereof, via wired or wireless connections.

The system can further comprise a property database (6) comprising color characteristics interrelated with color identifiers. The property database can further comprise interrelated wet target color characteristics, dry target color characteristics, color formulas, or a combination thereof. The property database can reside in the first computing device, the second computing device when present, a remote computing device, or a combination thereof and can be accessed from the first computing device or the second computing device when present.

The system can further comprise one or more subsequent computer program products that comprise computing program codes for wet-dry color correlations, one or more component adjustment functions, one or more component vector functions, or a combination thereof. The subsequent computer program products can reside in one or more digital storage devices, the first computing device, the second computing device when present, a remote computing device when present, or a combination thereof.

The liquid measuring devices can further comprise one or more pH measuring devices, one or more viscosity measuring devices, one or more conductivity measuring devices, one or more resistivity measuring devices, one or more weight measuring devices, one or more volume measuring devices, one or more hiding measuring devices, one or more sparkle measuring devices, or a combination thereof. Typical commercial or customized devices can be suitable. Hiding measuring devices such as the one disclosed in U.S. Pat. No. 7,925,468 can be suitable. The system can further comprise one or more adaptors to customize any of the devices for desired uses with the system. The system can further comprise one or more hiding marks for measuring hiding data.

As mentioned above, the system can be used for producing a target composition such as the aforementioned coating composition.

This disclosure is further directed to a kit for use in a system for producing a target composition having one or more target property values. The kit can comprise:

K1) a wet color measuring device for measuring wet color data of a specimen of the target composition;

K2) one or more digital storage devices containing a computing program product comprising computing program codes for:

F1) receiving the wet color data from the wet color measuring device;

F2) generating at least one specimen image comprising specimen color display values based on the wet color data; and

F3) displaying the at least one specimen image having the specimen color display values on one or more display devices when present.

The computing program product can further comprise computing program codes for:

F4) comparing the wet color data with one or more target property values of the target composition, wherein the target property values comprise wet target color characteristics of the target composition, dry target color characteristics of the target composition, or a combination thereof; and

F5) generating an output signal to output the target composition if each of the specimen property values is within a predetermined individual tolerance range, or generating an adjustment formula for producing a subsequent mixture of the target composition if at least one of the individual property values is not within the predetermined individual tolerance range, the adjustment formula comprises adjustment data of one or more individual components of the target composition, one or more adjustment components, or a combination thereof.

The computer program product can further comprise computing program codes for:

F6) outputting the adjustment formula to control one or more supply devices when present to supply one or more components to a mixing device when present according to the adjustment formula; and

F7) repeating the steps of (F1) through (F7) until each of the individual property values is within the predetermined individual tolerance range.

The computer program product can further comprise computing program codes for:

F6a) displaying the adjustment formula and the specimen image on the one or more display devices when present prior to the step D6); and

F6b) receiving an operation input selected from: a) proceeding to the step D6), b) terminating mixing operations of the system, or c) modifying the adjustment formula.

The computing program product can further comprise computing program codes for generating or retrieving one or more target images and displaying the target images on the one or more display devices when present.

The target images can comprise target color display values based on the wet target color characteristics or the dry target color characteristics.

The kit can comprise the aforementioned wet color measuring device. The wet color measuring device can comprise the thin film device selected from: a spinning disk device, a flow cell device, a coating application device, or a combination thereof.

The kit of this disclosure can further comprise:

K3) a first computing device (2); and

K4) one or more display devices (3), wherein the first computing device is capable to be functionally coupled to the wet color measuring devices, the one or more display devices, or a combination thereof.

The first computing device (2) can be a portable computing device functionally coupled to the wet color measuring device via wireless connections. Any of the aforementioned computing devices can also be suitable. The computer program product or a part thereof can be installed on the first computing device or a remote computing device, or a combination thereof.

The one or more digital storage devices can further contain computing codes for a property database (6). The database can comprise interrelated color characteristics, color identifiers, wet target color characteristics, dry target color characteristics, color formulas, or a combination thereof.

The one or more digital storage devices can further contain one or more subsequent computer program products that comprise computing program codes for wet-dry color correlation functions, one or more component adjustment functions, one or more component vector functions, or a combination thereof.

The kit can further comprise:

K5) at least one mixing device (4) for mixing one or more individual components of the target composition; and

K6) one or more supply devices (5) capable to be functionally coupled to the mixing device for supplying the one or more individual components to the mixing device.

The kit can further comprise:

K7) a second computing device capable to be functionally coupled to the one or more supply devices, and optionally to the mixing device, to control the one or more supply devices for supplying the one or more individual components to the mixing device according to a mixing input;

wherein the first computing device and the second computing device can be the same or different.

The computing program product of the kit can also comprise computing codes for controlling one or more mixing devices, one or more supply devices, or a combination thereof for supplying one or more individual components from the supply devices to the mixing device. Such codes can be present in the kit regardless of the presence of the mixing device or the supply devices.

The one or more digital storage devices can be any computer readable storage media and can be selected from a CD, a DVD, a high density DVD, a flash memory device, a hard drive, a network drive, a web drive, or a combination thereof.

The kit can further comprise one or more hiding marks for measuring hiding data.

The kit can further comprise an access connection data stored on one or more of the digital storage devices for accessing a color system, such as the aforementioned ColorNet® system. The access connection data can comprise a link to access the color system through a network connection selected from a wired connection, a wireless connection, or a combination thereof, to a remote computer server when the color system or a part thereof resides in the remote computer server. The access connection data can further comprise computing program codes for an authentication process such as requiring a user ID and password, or other authentication or security measurements.

A user can assemble the kit with other devices, adaptors, accessories, or a combination thereof, that are commonly available or known in the industry to form the system or to perform the process disclosed herein.

The present disclosure provides advantages for obtaining wet property data in real time while the target composition is still being mixed or just mixed and providing timely feedback for adjusting properties without the need for producing a dry test panel so the target composition can be produced to meet the desired property values without long time delay. The target composition can be mixed in a small scale in a lab mixing, in a large scale in a manufacturing facility, or a combination thereof. In one example, the system and the process can be used in a paint manufacturing facility. In another example, the system or a part thereof can be used at a paint mixing facility at a vehicle OEM facility. In yet another example, the system or a part thereof can be used at a refinish paint mixing facility. In yet another example, the system or a part thereof can be used at a vehicle refinish body shop. In yet another example, the kit or a part thereof can be provided to a user. In yet another example, the kit having the wet color measuring device and the computing program product or a part thereof can be provided to a user.

Although coating compositions are described, the process and the system disclosed herein can be used for producing a wide range of target compositions. Examples of the compositions that can be produced can include dyes, dispersions or emulsions, polymers, food mixtures, composite materials, concrete or other building materials, or a combination thereof.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example 1

A colored waterborne coating composition can be mixed in a mixing tank based on a color coating formula to form a color coating mixture (step 401) (FIG. 4A). A number of specimens of the color coating mixture can be taken at various time points during mixing. In this example, the specimen can be measured sequentially.

The specimen can be delivered to a pH measuring device for measuring pH data (step 402). If the pH data is not within a predetermined tolerance range (step 403), pH of the color coating mixture can be adjusted (step 404) using acid or base. A liquid base can be used. If the pH data is within the predetermined tolerance range, the specimen can be delivered to a viscosity meter for measuring viscosity data (step 405).

If the viscosity data is not within a predetermined tolerance range (step 406), viscosity of the color coating mixture can be adjusted (step 407) using solvents or solids. If the viscosity data is within the predetermined tolerance range, the specimen can be delivered to a wet color measuring device for measuring wet color data (step 408).

If the color data is not within a predetermined tolerance range (step 409), color of the color coating mixture can be adjusted (step 410) using pigment, dyes, polymers, solvents, solids, or a combination thereof based on color adjustment function or adjustment formula. If the color data is within the predetermined tolerance range and all the predetermined key adjustable properties (KAP), such as pH, viscosity and color in this example, are all assured to be within the predetermined tolerance range (step 411), the colored coating composition can be produced and outputted (step 412) directly to a receiving device, such as a product storage tank, without the need for producing a dry test panel.

Different sequence of measurements can be suitable. The viscosity or the color can be measured before the pH. Optionally, the viscosity data or the color data can be measured without the pH data (dashed lines in FIG. 4A).

### Example 2

In this example, the specimen can be divided into 3 portions and the pH data, the viscosity data and the color data can be measured simultaneously (FIG. 4B). Each of the properties can be adjusted accordingly. Once all the predetermined key adjustable properties (KAP), such as pH, viscosity and color in this example, are all assured to be within the predetermined tolerance range (step 411), the colored coating composition can be produced and outputted (step 412) to a receiving device, such as a product storage tank, without the need for producing a dry test panel.

### Example 3

In this example, properties of the specimen can be measured simultaneously or sequentially (FIG. 4C). Instead of adjusting each of the properties separately, a composite adjustment mixture can be formed (step 413) to adjust the measured properties at once.

This composite adjustment can be advantageous. For instance, adding liquid base can not only increase pH, but also reduce viscosity, and can possibly further change the color. In another instance, adding pigments can change color and also viscosity, and possibly pH depending on the pigments composition. The composite adjustment can be based on one or more component adjustment functions.

Once all the predetermined key adjustable properties (KAP), such as pH, viscosity and color in this example, are all assured to be within the predetermined tolerance range (step 411), the colored coating composition can be produced and outputted (step 412) to a receiving device, such as a product storage tank, without the need for producing a dry test panel.

### Example 4

This example illustrates a color comparing process (FIG. 5). The wet color data (step 501) obtained from the color measuring step (step 408) can be used to produce a specimen image (step 502) and displayed on a display device (step 503). The specimen image can be compared to samples of the target composition (step 504) or target images displayed on the same or different display devices (step 505). One example of the display can include the one shown in FIG. 6A. The visual color difference can be assessed (step 506).

Alternatively, the wet color data can be compared to wet target color characteristics or dry target color characteristics stored in a color database using one of the color difference calculation methods disclosed herein (step 508) to generate color value difference (step 509).

The color difference can be compared to a predetermined color difference tolerance range (step 507).

### Examples 5

A blue metallic coating composition having target color characteristics in L*,a*,b* color values and the tolerance range shown in Table 1 was produced according to an initial formulation in Table 2. An initial product had measured specimen color data shown in Table 3.

TABLE 1
Target color characteristics and tolerance range.

| | Target Color Characteristics | | | Tolerance Range | | |
|---|---|---|---|---|---|---|
| | 15° | 45° | 110° | 15° | 45° | 110° |
| L* | 95.92 | −12.87 | −19.74 | ±1.5 | ±0.3 | ±0.6 |
| a* | 46.67 | −6.19 | −16.06 | ±1.5 | ±0.3 | ±0.6 |
| b* | 26.50 | −3.27 | −19.69 | ±1.5 | ±0.3 | ±0.6 |

TABLE 2
Initial color formulation.

| Color Tints ¹ | Weight % |
|---|---|
| 813J ™ (Medium Coarse Aluminum) | 23.92 |
| 821J ™ (Violet Blue) | 37.06 |
| 802J ™ (White(LS)) | 18.16 |
| 811J ™ (Medium Aluminum) | 13.82 |
| 829J ™ (Light Blue) | 7.04 |
| Total | 100 |

¹ The tints used were MasterTint ®, under respective trademarks or registered trademarks, available from E.I. du Pont de Nemours and Company, Wilmington, DE, USA.

TABLE 3
Color data value differences of the initial product.

| | 15° | 45° | 110° |
|---|---|---|---|
| ΔL | −4.78 | −0.21 | −3.56 |
| Δa | −3.05 | 0.85 | −1.88 |
| Δb | −2.26 | 2.05 | −1.30 |

The color value differences (Table 3) were not within the predetermined tolerance range shown in Table 1. A modified formulation was produced as shown in Table 4. A subsequent product was produced based on the modified formulation. The color data of the subsequent product were obtained and the color differences were within the tolerance range (Table 5). The subsequent product was produced as the target Metallic coating composition.

TABLE 4
Modified formulation.

| Color Tints ¹ | Weight % |
|---|---|
| 813J ™ (Medium Coarse Aluminum) | 30.75 |
| 821J ™ (Violet Blue) | 28.19 |
| 802J ™ (White(LS)) | 19.11 |
| 811J ™ (Medium Aluminum) | 14.54 |
| 829J ™ (Light Blue) | 7.41 |
| Total | 100.00 |

¹ Same as that of Table 2.

TABLE 5
Color data value differences of the subsequent product.

| | 15° | 45° | 110° |
|---|---|---|---|
| ΔL | 1.40 | −0.02 | 0.06 |
| Δa | 1.21 | 0.15 | 0.50 |
| Δb | −1.10 | 0.22 | −0.58 |

### Examples 6

A light oak solid color coating composition having target color characteristics in L*,a*,b* color values and the tolerance range shown in Table 6 was produced according to an initial formulation in Table 7. An initial product had measured specimen color data shown in Table 6.

TABLE 6
Target color characteristics and tolerance range.

| | | | | Subsequent color |
|---|---|---|---|---|
| | Target Color | Tolerance | Initial color data | data value |
| | Characteristics | Range | value differences | differences |
| | 45° | 45° | 45° | 45° |
| L* | 57.05 | ±0.3 | ΔL = −1.13 | ΔL = 0.15 |
| a* | 4.77 | ±0.3 | Δa = 0.1 | Δa = 0 |
| b* | 15.15 | ±0.3 | Δb = 0.17 | Δb = 0.07 |

TABLE 7
Color formulation.

| | Initial Formulation | Modified Formulation |
|---|---|---|
| Color Tints ¹ | Weight % | Weight % |
| 801J ™ (White(HS)) | 57.62 | 59.85 |
| 845J ™ (Transparent Yellow) | 20.11 | 19.06 |
| 884J ™ (Red Oxide(LS)) | 16.10 | 15.25 |
| 805J ™ (Jet Black) | 6.17 | 5.84 |
| Total | 100.00 | 100.00 |

¹ The tints used were MasterTint ®, under respective trademarks or registered trademarks, available from E.I. du Pont de Nemours and Company, Wilmington, DE, USA.

The initial color value differences (Table 6) were not within the predetermined tolerance range. A modified formulation was produced as shown in Table 7. A subsequent product was produced based on the modified formulation. The color data of the subsequent product were obtained and the subsequent color differences were within the tolerance range (Table 6). The subsequent product was produced as the target coating composition.

1. A system for producing a target composition having one or more target property values, the system comprising:
(A) one or more liquid measuring devices (1) for measuring specimen property values of a specimen of the target composition, the one or more liquid measuring devices comprise a wet color measuring device for obtaining wet color data of the specimen;
(B) a first computing device (2);
(C) one or more display devices (3), wherein the first computing device is functionally coupled to the one or more liquid measuring devices, the one or more display devices, or a combination thereof; and
(D) one or more digital data storage devices containing a computing program product functionally coupled to the first computing device, the computing program product comprises computing program codes for:
D1) receiving the specimen property values from the one or more liquid measuring devices;
D2) generating at least one specimen image comprising specimen color display values based on the wet color data; and
D3) displaying the at least one specimen image having the specimen color display values on the one or more display devices.

2.-18. (canceled)
